(19) United States
(12) Patent Application Publication
(10) Pub. No.: US 2023/0244345 A1
(43) Pub. Date: Aug. 3, 2023

(54) ELECTRONIC APPARATUS AND METHOD FOR CONTROLLING ELECTRONIC APPARATUS

(71) Applicant: PANASONIC INTELLECTUAL PROPERTY MANAGEMENT CO., LTD., Osaka (JP)

(72) Inventors: Shuto UWAI, Kanagawa (JP); Tomoki TAKANO, Kanagawa (JP); Yusaku SHODA, Kanagawa (JP)

(73) Assignee: PANASONIC INTELLECTUAL PROPERTY MANAGEMENT CO., LTD., Osaka (JP)

(21) Appl. No.: 18/104,466

(22) Filed: Feb. 1, 2023

(30) Foreign Application Priority Data
Feb. 2, 2022 (JP) 2022-014934

(51) Int. Cl. G06F 3/041

(52) U.S. Cl. CPC G06F 3/04186

(57) ABSTRACT

An electronic apparatus includes a touch panel, sensors for detecting water droplets, and a processor for reducing a detection sensitivity of the touch panel in a case that the sensors detect water droplets. The sensors are arranged along at least part of an outer circumference of the touch panel and in series along one edge of the touch panel on a side gripped by a user.

### CROSS-REFERENCE TO RELATED APPLICATIONS

This application is based on and claims priority under 35 USC 119 from Japanese Patent Application No. 2022-014934 filed on Feb. 2, 2022, the contents of which are incorporated herein by reference.

### TECHNICAL FIELD

The present disclosure relates to an electronic apparatus and a method for controlling an electronic apparatus.

### BACKGROUND ART

A touch panel that detects an input operation by an indicator such as a finger is known in the related art. The touch panel is generally attached to a display device of an electronic apparatus. Thus, the touch panel provides a user interface of the electronic apparatus. Examples of the touch panel include a resistive film touch panel and an electrostatic capacitance touch panel.

An example of the touch panel in the related art includes a touch panel including: a touch screen substrate on which a plurality of electrostatic capacitance detection wires are disposed; a transparent substrate that overlaps the touch screen substrate and has one main surface come into contact with an indicator; and an electrostatic capacitance detection circuit that detects a change in electrostatic capacitance between the indicator and the plurality of electrostatic capacitance detection wires when the indicator comes into contact with the transparent substrate and detects a contact position of the indicator on the transparent substrate. The transparent substrate has an additional electrode in a region that does not overlap a sensor effective region of the touch screen substrate. The additional electrode is electrically connected to the electrostatic capacitance detection circuit (see Patent Literature 1).

### CITATION LIST

### Patent Literature

Patent Literature 1: JP2013-125496A

### SUMMARY OF INVENTION

When water droplets or the like adhere to a display device having a touch panel, electrostatic capacitance may change and a malfunction may occur in the touch panel. In particular, the number of electrodes is small in an outer circumference portion of the touch panel, and thus it is difficult to distinguish whether an object detected by the touch panel is an indicator or water droplets. As a result, a malfunction of the touch panel may occur. Patent Literature 1 does not consider prevention of a malfunction of the touch panel due to adhesion of water droplets in consideration of an outer circumference portion of the touch panel. For this reason, for example, when water droplets accumulate on a boundary line between the outer circumference portion of the touch panel and a housing to which the touch panel is attached, the malfunction of the touch panel may continue and operability may decrease.

The present disclosure provides an electronic apparatus and a method for controlling an electronic apparatus that can prevent a malfunction of a touch panel even when water droplets adhere to an outer circumference portion of the touch panel.

According to an aspect of the present disclosure, there is provided an electronic apparatus including a touch panel; sensors for detecting water droplets; and a processor for reducing a detection sensitivity of the touch panel in a case that the sensors detect water droplets. The sensors are arranged along at least part of an outer circumference of the touch panel and in series along one edge of the touch panel on a side gripped by a user.

Also, according to an aspect of the present disclosure, there is provided a method of controlling an electronic apparatus including a touch panel, and sensors for detecting water droplets and arranged in series along one edge of the touch panel on a side gripped by a user. The method includes determining a type of water droplets detected by the sensors; and determining that the detected water droplets are not sweat droplets in a case that at least two of the sensors detect the water droplets.

According to the present disclosure, a malfunction of a touch panel can be prevented even when water droplets adhere to an outer circumference portion of the touch panel.

### BRIEF DESCRIPTION OF DRAWINGS

Exemplary embodiments of the present invention will be described in detail based on the following figures, wherein:

FIG. 1 is an overall configuration view of an electronic apparatus including a touch panel according to a first embodiment of the present disclosure;

FIG. 2 is a cross-sectional view taken along a line A-A in FIG. 1;

FIG. 3 is a block diagram showing a configuration example of the electronic apparatus;

FIG. 4 is an image diagram showing that a detection signal of an indicator and a detection signal of water are in opposite phases;

FIG. 5 is a flowchart showing a procedure for executing a method for controlling an electronic apparatus according to the first embodiment of the present disclosure;

FIG. 6 is an overall configuration view of an electronic apparatus including a touch panel according to a second embodiment of the present disclosure; and

FIG. 7 is a flowchart showing a procedure for executing a method for controlling an electronic apparatus according to the second embodiment of the present disclosure.

### DESCRIPTION OF EMBODIMENTS

Hereinafter, embodiments specifically disclosing an electronic apparatus and a method for controlling an electronic apparatus according to the present disclosure will be described in detail with reference to the drawings appropriately. Unnecessary descriptions in detail may be omitted. For example, detailed descriptions of a well-known matter and repeated descriptions of substantially the same configuration may be omitted. This is to avoid unnecessary redundancy in the following description and to facilitate understanding of those skilled in the art. The accompanying drawings and the following descriptions are provided for those skilled in the art to fully understand the present disclosure, and are not intended to limit a subject matter of the claims.

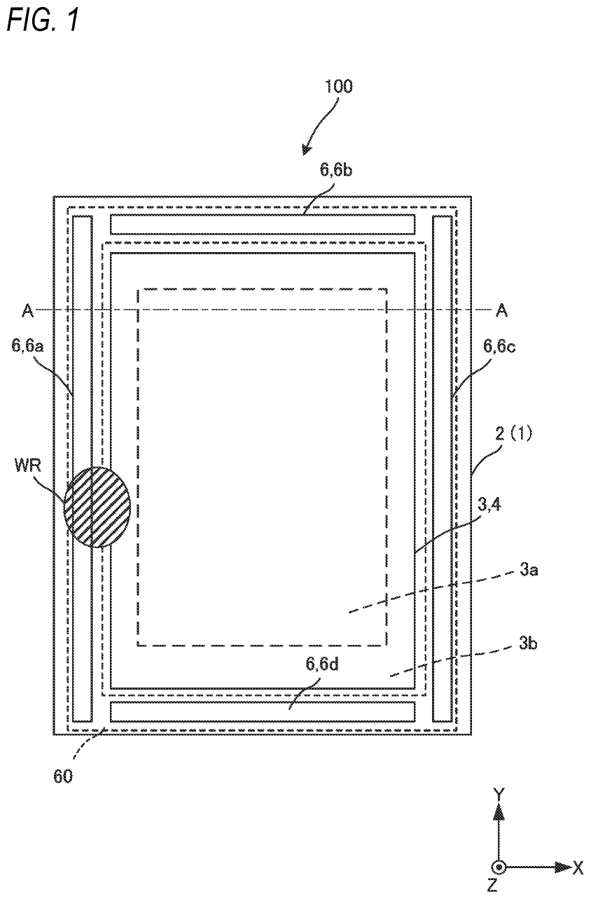

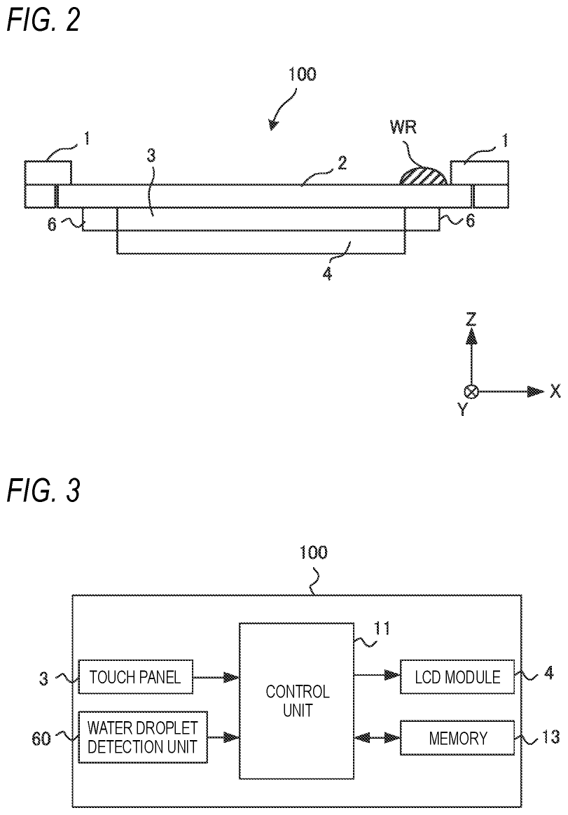

FIG. 1 is an overall configuration view of an electronic apparatus including a touch panel according to an embodiment of the present invention. FIG. 2 is a cross-sectional view taken along a line A-A in FIG. 1. In the drawings, an X direction is a direction (for example, lateral direction) along a touch panel surface, a Y direction is a direction (for example, longitudinal direction) perpendicular to the X direction along the touch panel surface, and a Z direction is a direction perpendicular to the touch panel surface.

An electronic apparatus 100 includes a housing 1, a protective plate 2, a touch panel 3, a liquid crystal display (LCD) module 4, and a water droplet detection unit 60. The electronic apparatus 100 is, for example, a settlement processing apparatus that performs settlement processing.

The housing 1 constitutes an exterior of the electronic apparatus 100 and houses other components. The protective plate 2 is made of, for example, glass, is disposed above the touch panel 3, and protects the touch panel 3.

The touch panel 3 provides a user interface that detects an input operation by a finger of a user or an indicator such as a stylus pen. Examples of the touch panel 3 include various types of touch panels such as a resistive film touch panel and an electrostatic capacitance touch panel, and the type of the touch panel 3 is not particularly limited. The touch panel 3 includes a central portion 3a including a vicinity of a center and an outer circumference portion 3b located on an end portion side relative to the central portion 3a. The touch panel 3 includes more electrodes that detect an input operation at the central portion 3a than at the outer circumference portion 3b. For this reason, in the touch panel 3, the central portion 3a is more likely to detect an input operation on the touch panel 3 by an indicator than the outer circumference portion 3b is.

The LCD module 4 is a so-called liquid crystal display device, and includes various members such as a liquid crystal cell and a polarizing plate, and the type of the LCD module 4 is not particularly limited. Another display device (for example, organic electroluminescence) may be used instead of the LCD module 4.

The electronic apparatus 100 may be a fixed apparatus (stationary) or a portable apparatus (portable or handheld). The electronic apparatus 100 may have a size similar to that of a smartphone, for example, and may be a tablet terminal.

The water droplet detection unit 60 is provided to at least a part of a periphery of the touch panel 3 along an outer periphery of the touch panel 3. The water droplet detection unit 60 includes one or more water droplet detection sensors 6 and detects water droplets WR. The water droplet detection sensors 6 are disposed, for example, in a vicinity of corresponding end sides of the touch panel 3. The water droplet detection sensor 6 detects the water droplets WR adhering to the outer circumference portion 3b (outer edge portion) of the touch panel 3 (on the protective plate 2). The outer circumference portion 3b of the touch panel 3 that is a detection target of the water droplets WR may include not only a part inside the touch panel 3 but also a part outside the touch panel 3. Examples of the water droplet detection sensor 6 include various types of sensors such as an electrostatic capacitance sensor, a photoelectric sensor, and an ultrasonic sensor, and the type of the water droplet detection sensor 6 is not particularly limited.

In the electronic apparatus 100 as shown in FIG. 1, the housing 1 has a rectangular shape in a plan view in many cases, and the touch panel 3 also has a rectangular shape in a plan view. Examples of the water droplet detection sensor 6 include four water droplet detection sensors 6 (6a, 6b, 6c, 6d) arranged along respective four sides that are outer circumference sides of the touch panel 3 having a rectangular shape in a plan view. Each of the four water droplet detection sensors 6 detects the water droplets WR. Therefore, for example, the electronic apparatus 100 can detect the water droplets WR by the four water droplet detection sensors 6 even when the water droplets WR adhere to any position (for example, a positive side in the X direction, a negative side in the X direction, a positive side in the Y direction, a negative side in the Y direction) of the outer circumference portion 3b of the touch panel 3.

An arrangement position, the number, and the like of the water droplet detection sensor 6 in the electronic apparatus 100 are not limited to those in FIG. 1. For example, the number of the water droplet detection sensor 6 may be three, and the water droplet detection sensor 6d along the X direction on the negative side in the Y direction among the four water droplet detection sensors 6 shown in FIG. 1 may not be provided. In this case, for example, even when the electronic apparatus 100 is a handheld type and the user grips a negative side in the Y direction thereof, it is possible to prevent erroneous detection of a hand or finger of the user and the water droplets WR.

As shown in FIG. 2, the protective plate 2, the touch panel 3, and the LCD module 4 are arranged in order from the positive side (upper side) in the Z direction. On the negative side (lower side) in the Z direction of the protective plate 2, the water droplet detection unit 60 (water droplet detection sensor 6) is provided outside the touch panel 3.

As shown in FIG. 2, the housing 1, to which the touch panel 3 and the like is attached, protrudes to the positive side in the Z direction at an outer circumference portion of the electronic apparatus 100. That is, the inside of the outer circumference portion of the electronic apparatus 100 surrounded by a part of the housing 1 is one step lower than the housing 1 in the Z direction. That is, in the electronic apparatus 100, the housing 1 around a screen (touch panel 3) is higher than the screen, so that robustness is ensured and the screen is less likely to be broken. On the other hand, the water droplets WR are likely to accumulate in the part of the housing 1 that is one step higher and a part of the protective plate 2 that is one step lower. For example, when the electronic apparatus 100 is used on a rainy day, the water droplets WR are likely to accumulate, and electrostatic capacitance of the touch panel 3 is likely to change due to the water droplets WR, and the touch panel is likely to malfunction.

Therefore, it is beneficial that the electronic apparatus 100 detects the water droplets WR and controls detection by the touch panel according to presence or absence of the water droplets WR, thereby preventing erroneous detection of an input to the touch panel 3.

FIG. 3 is a block diagram showing a configuration example of the electronic apparatus 100. The electronic apparatus 100 includes the touch panel 3, the LCD module 4, the water droplet detection sensor 6, a control unit 11, and a memory 13.

The control unit 11 includes, for example, a processor. The processor implements various functions of the control unit 11 by executing a program held in the memory 13. The processor may include a micro processing unit (MPU), a central processing unit (CPU), a digital processor (DSP), or the like. The processor may be implemented by various integrated circuits (for example, large scale integration (LSI), field programmable gate array (FPGA)). The control unit 11 integrally controls units of the electronic apparatus 100 and performs various types of processing.

The memory 13 stores various data, information, programs, and the like. The memory 13 includes a primary storage device (for example, random access memory (RAM), read only memory (ROM)), and is, for example, a flash memory. The memory 13 may include a memory other than the primary storage device.

When at least one of the plurality of water droplet detection sensors 6 disposed around the touch panel 3 detected the water droplets WR, the control unit 11 determines that the water droplets WR are present on the outer circumference portion 3b of the touch panel 3.

The control unit 11 sets an operation mode of the electronic apparatus 100. The operation mode of the electronic apparatus 100 includes at least a normal mode in which detection sensitivity is normally set to a first detection sensitivity without consideration of the water droplets WR, and a water droplet handling mode in which the detection sensitivity is set to a second detection sensitivity in consideration of the water droplets WR. Setting information on the operation mode is held in the memory 13. The second detection sensitivity is lower than the first detection sensitivity. That is, a threshold value for detection in the water droplet handling mode is larger than a threshold value for detection in the normal mode. Therefore, when the water droplets WR are present, the touch panel 3 is set to the water droplet handling mode, which is an operation mode in which it is less likely for the touch panel 3 to detect an input operation, and malfunction of the touch panel 3 can be prevented.

In the normal mode, the detection sensitivity may be constant in the central portion 3a and the outer circumference portion 3b of the touch panel 3. However, since the number of electrodes for detection is smaller in the outer circumference portion 3b than in the central portion 3a, it is less likely for the outer circumference portion 3b to detect an input operation. In the water droplet handling mode, the control unit 11 controls the detection sensitivity to be lower than that in the normal mode. In this case, the control unit 11 may lower the detection sensitivity in both the central portion 3a and the outer circumference portion 3b of the touch panel 3, or may lower the detection sensitivity only in the outer circumference portion 3b without changing the detection sensitivity in the central portion 3a of the touch panel 3. That is, in the water droplet handling mode, the detection sensitivity in the outer circumference portion 3b may be lower as compared with that in the normal mode, and the detection sensitivity in the central portion 3a may be the same or lower.

The control unit 11 may set the operation mode according to whether the water droplets WR are present on the outer circumference portion 3b of the touch panel 3. When it is determined that the water droplets WR are not present on the outer circumference portion 3b of the touch panel 3, the control unit 11 sets the operation mode to the normal mode. When it is determined that the water droplets WR are present on the outer circumference portion 3b of the touch panel 3, the control unit 11 sets the operation mode to the water droplet handling mode. Therefore, when the water droplets WR are present on the outer circumference portion 3b of the touch panel 3, the control unit 11 lowers the detection sensitivity of the touch panel 3 as compared with the case in which the water droplets WR are not present on the outer circumference portion 3b of the touch panel 3.

For example, when a state in which the water droplets WR are detected by the water droplet detection sensor 6 is changed to a state in which no water droplets WR are detected by the water droplet detection sensor 6, the control unit 11 changes the operation mode from the normal mode to the water droplet handling mode, and thus lowers the detection sensitivity of the touch panel 3. On the contrary, when the state in which no water droplets WR are detected by the water droplet detection sensor 6 is changed to the state in which the water droplets WR are detected by the water droplet detection sensor 6, the control unit 11 changes the operation mode from the water droplet handling mode to the normal mode, and thus raises the detection sensitivity of the touch panel 3.

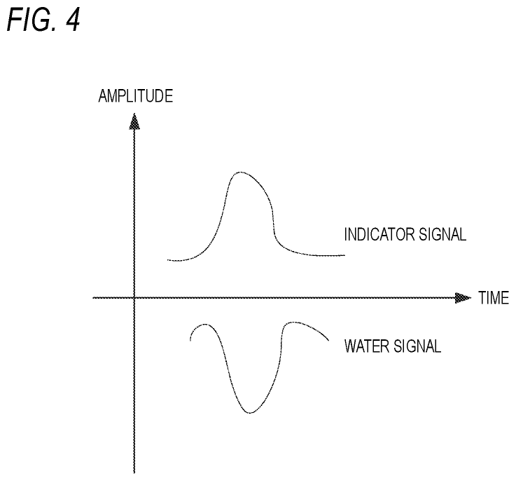

FIG. 4 is an image diagram showing that a detection signal of an indicator and a detection signal of water are in opposite phases.

In FIG. 4, a horizontal axis represents time, a vertical axis represents signal amplitude (signal level), and the electrostatic capacitance at the time of detection by the touch panel 3 is shown. In FIG. 4, it can be understood that an indicator signal generated when an indicator such as a finger is in proximity to the touch panel 3 and a water signal generated when the water droplets WR adhere to the touch panel 3 have opposite phases with reference to respective signal waveforms. The touch panel 3 includes a large number of electrodes that detect an input in the central portion 3a, and thus the indicator signal and the water signal can be easily distinguished from each other. On the other hand, the touch panel 3 includes a small number of electrodes that detect an input in the outer circumference portion 3b, and thus it is not easy to distinguish between the indicator signal and the water signal, and the accuracy of distinguishing a type of an object may be low. In response to this, in the present embodiment, the electronic apparatus 100 includes the water droplet detection sensor 6 separately from sensors (electrodes) provided in the touch panel 3, so that the sensors in the outer circumference portion of the touch panel 3 are complimented, and the detection of the water droplets WR and the detection of the indicator are easily distinguished from each other. This also applies to a second embodiment.

A sample of a signal waveform of the water signal and a sample of the water signal may be held in the memory 13 in advance. The control unit 11 can determine whether the water droplet detection sensor 6 detected an object other than the water droplets WR such as an indicator or detected the water droplets WR by comparing a detection signal detected by the water droplet detection sensor 6 with a sample of each signal held in the memory 13.

Next, an operation example of the electronic apparatus 100 will be described.

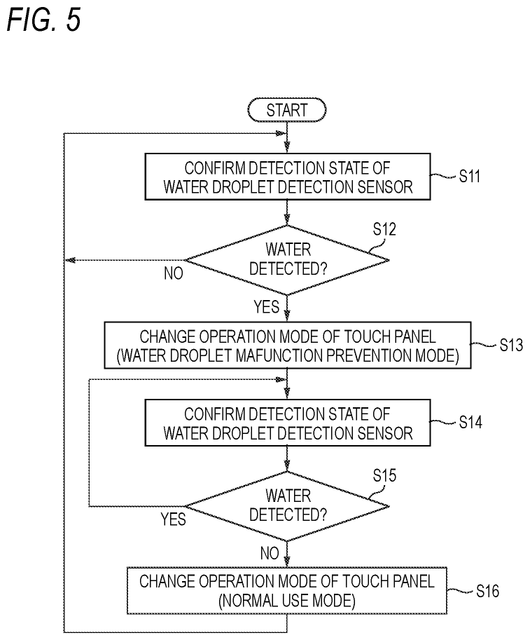

FIG. 5 is a flowchart showing a procedure for executing an example of a method for controlling the electronic apparatus 100. The control unit 11 executes steps of the control method. For example, the control unit 11 reads a control program of the electronic apparatus 100 stored in the memory 13 and executes the control method. Before the process of FIG. 5, the operation mode is set to, for example, the normal mode.

The control unit 11 confirms a detection state of the water droplet detection sensor 6 (step S11), and determines whether the water droplets WR are detected by the water droplet detection sensor 6 (step S12). For example, the control unit 11 determines whether at least one water droplet detection sensor 6 disposed around the touch panel 3 detected the water droplets WR. When no water droplets WR are detected, the control unit 11 repeats the confirmation of the detection state of the water droplet detection sensor.

When the water droplets WR are detected by the water droplet detection sensor 6, the control unit 11 sets (changes) the operation mode of the touch panel 3 to the water droplet handling mode (step S13).

After the processing of step S13, the control unit 11 confirms the detection state of the water droplet detection sensor 6 again (step S14), and determines whether the water droplets WR are detected by the water droplet detection sensor 6 (step S15). A method for detecting water droplets in steps S14 and S15 may be the same as a method for detecting water droplets in steps S11 and S12. When the water droplets WR are detected, the control unit 11 repeats the confirmation of the detection state of the water droplet detection sensor 6. In this case, it is shown that a state in which the water droplets WR adhere to the outer circumference portion 3b of the touch panel 3 continues. For this reason, the water droplet handling mode continues, thereby preventing the malfunction of the touch panel 3 due to the water droplets WR.

When no water droplets WR are detected by the water droplet detection sensor 6, the control unit 11 sets (changes) the operation mode of the touch panel 3 to the normal mode (step S16). That is, when no water droplets WR are detected by the water droplet detection sensor 6 any more, the control unit 11 restores the detection sensitivity of the touch panel 3 to the detection sensitivity before the lowering. That is, the water droplets WR are not present from a state in which the water droplets WR adhere due to being wiped off, falling to the outside of the electronic apparatus 100, and evaporating, and thus the operation mode is set to the normal mode. Even in this case, a malfunction of the touch panel 3 can be prevented since the water droplets WR are not present. Then, the control unit 11 repeats the step S11 and the subsequent steps.

In this manner, the electronic apparatus 100 includes the water droplet detection unit 60 including a plurality of water droplet detection sensors 6 around an outer side of the touch panel 3. Accordingly, in the electronic apparatus 100, the water droplet detection unit 60 functionally compensates for the difficulty in detecting the water droplets WR on the outer circumference portion 3b by the sensors of the touch panel 3. For this reason, when the water droplet detection unit 60 detected the water droplets WR, the electronic apparatus 100 can automatically change the operation mode to the water droplet handling mode, and can change the detection sensitivity of the touch panel 3 while preventing the deterioration of the operability of the user. That is, the electronic apparatus 100 can prevent the water droplets WR from being erroneously detected as an input by lowering the detection sensitivity of the touch panel 3 during the setting of the normal mode (normal time).

When the water droplet detection unit 60 detected no water droplets WR any more, the electronic apparatus 100 ends the water droplet handling mode and raises (restores) the detection sensitivity. Therefore, the electronic apparatus 100 can quickly eliminate the state in which the detection sensitivity of the touch panel 3 for an original input operation is low and restore the detection sensitivity to the normal detection sensitivity. That is, the electronic apparatus 100 makes the state in which the detection sensitivity of the touch panel 3 is low as short as possible.

In addition, when the detection sensitivity of the central portion 3a is not lowered in the water droplet handling mode as compared with that in the normal mode, the electronic apparatus 100 can continue the detection of an input operation in the central portion 3a in the same manner as in the normal time, and can avoid affecting the detection of an indicator and the like by the touch panel 3.

### Second Embodiment

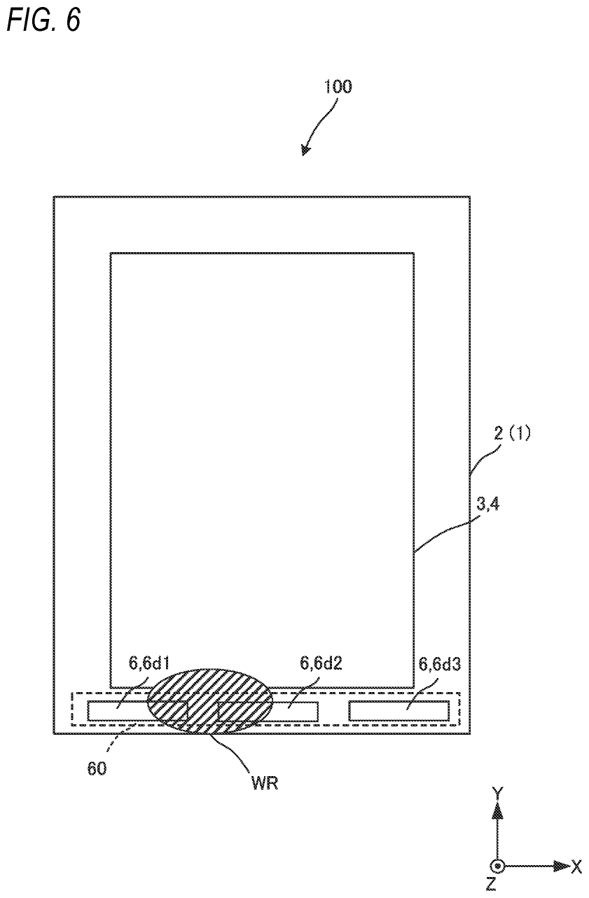

In the second embodiment, it is assumed that a user grips an electronic apparatus 100A. For example, an end portion in one direction (for example, the negative side in the Y direction) of an operation display surface (touch panel surface) of the rectangular electronic apparatus 100A is a portion where the electronic apparatus 100A is usually gripped (see FIG. 6).

FIG. 6 is an overall configuration view of an electronic apparatus including a touch panel according to the present embodiment. In the electronic apparatus 100A of FIG. 6, the same components as those of the electronic apparatus 100 shown in FIG. 1 are denoted by the same reference numerals, and descriptions thereof will be omitted or simplified. In FIG. 6, configurations other than the water droplet detection sensor 6 are substantially the same as those in FIG. 1.

In the electronic apparatus 100A, a plurality of water droplet detection sensors 6 are provided along an end portion in one direction (for example, the negative side in the Y direction) of the touch panel 3. For example, the water droplet detection sensors 6 are arranged in series along one end side of the touch panel 3. In FIG. 6, three water droplet detection sensors 6 (6d1, 6d2, 6d3) are provided in series outside the touch panel 3 on the negative side in the Y direction.

The control unit 11 may confirm detection states of the plurality of water droplet detection sensors 6 and determine the presence or absence of the water droplets WR adhering to the outer circumference portion 3b of the touch panel 3 or the type (water droplets WR or sweat droplets) of the water droplets WR adhering to the outer circumference portion 3b.

For example, the control unit 11 may detect adhesion of an object (water droplets) by at least one water droplet detection sensor 6, and determine that the water droplets WR are adhering to the outer circumference portion 3b of the touch panel 3 when a detection signal of the object coincides with the water signal described above.

For example, when at least two water droplet detection sensors 6 (for example, all of the three water droplet detection sensors 6) detected adhesion of an object (water droplets), the control unit 11 may determine that the water droplets WR are adhering to the outer circumference portion 3b of the touch panel 3. In this case, for example, even when one water droplet detection sensor 6 detected sweat droplets of a hand of the user due to the griping by the user, the electronic apparatus 100A may detect the water droplets WR to be originally detected, which are not sweat droplets, by the other water droplet detection sensors 6. Even in such a case, the electronic apparatus 100A can improve the detection accuracy of the water droplets WR by determining the water droplets WR to be detected in consideration of the detection of the water droplets WR by the plurality of water droplet detection sensors 6.

In the electronic apparatus 100A as shown in FIG. 6, the housing 1 has a rectangular shape in a plan view in many cases, and the touch panel 3 also has a rectangular shape in a plan view. Examples of the water droplet detection sensor 6 include three water droplet detection sensors 6 (6d1, 6d2, 6d3) arranged along one side that is an outer circumference side of the touch panel 3 having a rectangular shape in a plan view. Each of the three water droplet detection sensors 6 can detect the water droplets WR. Therefore, the electronic apparatus 100A can detect, by the three water droplet detection sensors 6, the water droplets WR accumulated in one direction located on a lower side in the gravity direction when the user grips the electronic apparatus 100A. Further, since the water droplets WR are detected by at least two water droplet detection sensors 6, the water droplets WR to be detected can be detected in distinction from sweat droplets with high accuracy. An arrangement position, the number, and the like of the water droplet detection sensor 6 in the electronic apparatus 100A are not limited to those in FIG. 6.

Next, an operation example of the electronic apparatus 100A will be described.

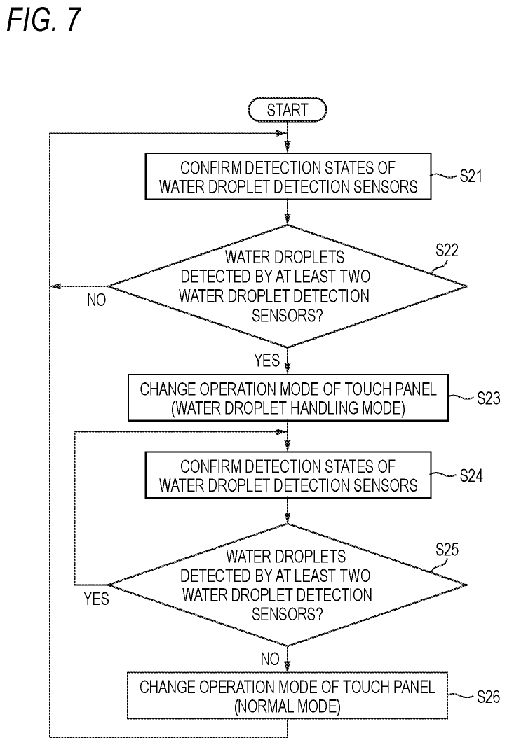

FIG. 7 is a flowchart showing a procedure for executing an example of a method for controlling the electronic apparatus 100A. The control unit 11 executes steps of the control method. For example, the control unit 11 reads a control program of the electronic apparatus 100A stored in the memory 13 and executes the control method. Before the process of FIG. 7, the operation mode is set to, for example, the normal mode. Although the electronic apparatus 100A detects the water droplets WR by at least two water droplet detection sensors 6 here, the electronic apparatus 100A may detect the water droplets WR by one water droplet detection sensor 6 as described above.

The control unit 11 confirms detection states of the water droplet detection sensors 6 (step S21), and determines whether the water droplets WR are detected by the water droplet detection sensors 6 (step S22). For example, the control unit 11 determines whether at least two water droplet detection sensors 6 arranged along an end portion in one direction of the touch panel 3 detected the water droplets WR. When zero or one water droplet detection sensor 6 detected no water droplets WR, the control unit 11 repeats the confirmation of the detection states of the water droplet detection sensors 6. This is because no water droplets WR may be detected or the water droplets WR may be sweat droplets by the user.

When at least two water droplet detection sensors 6 detected the water droplets WR, the control unit 11 determines that the water droplets WR being not sweat droplets are detected by the water droplet detection sensors 6, and sets (changes) the operation mode of the touch panel 3 to the water droplet handling mode (step S23).

After the processing of step S23, the control unit 11 confirms the detection states of the water droplet detection sensors 6 again (step S24), and determines whether the water droplets WR are detected by the water droplet detection sensors 6 (step S25). A method for detecting water droplets in steps S24 and S25 may be the same as a method for detecting water droplets in steps S21 and S22. When the water droplets WR are detected, the control unit 11 repeats the confirmation of the detection states of the water droplet detection sensors 6. In this case, it is shown that a state in which the water droplets WR adhere to the outer circumference portion 3b of the touch panel 3 (particularly, a lower end portion when the user grips the electronic apparatus 100A) continues. For this reason, the water droplet handling mode continues, thereby preventing the malfunction of the touch panel 3 due to the water droplets WR.

When no water droplets WR are detected by the water droplet detection sensors 6, the control unit 11 sets (changes) the operation mode of the touch panel 3 to the normal mode (step S26). That is, the water droplets WR are not present from a state in which the water droplets WR adheres due to being wiped off, falling to the outside of the electronic apparatus 100A, and evaporating, and thus the operation mode is set to the normal mode. Even in this case, the malfunction of the touch panel 3 can be prevented since the water droplets WR are not present. Then, the control unit 11 repeats the step S21 and the subsequent steps.

In this manner, the electronic apparatus 100A can obtain the same effects as those of the electronic apparatus 100 according to the first embodiment. Further, the electronic apparatus 100A can distinguish sweat droplets of a hand of the user and improve the detection accuracy of the water droplets WR by determining that the water droplets WR to be detected is detected when the water droplet is detected by a plurality of water droplet detection sensors 6.

### OTHER EMBODIMENTS

Next, variations of the above-described embodiments will be described.

Shapes and the number of the water droplet detection sensors 6 are not limited to shapes and the number shown in FIG. 1 or FIG. 6. For example, the plurality of water droplet detection sensors 6 may include the L-shaped water droplet detection sensor 6, and the L-shaped water droplet detection sensor 6 may surround a part of a periphery of the touch panel 3.

As described above, the electronic apparatus 100 of the present embodiment includes the touch panel 3, the water droplet detection unit 60 that is provided in at least a part in a vicinity of the touch panel 3 along the outer periphery of the touch panel 3 and detects the water droplets WR, and the control unit 11 that lowers detection sensitivity of the touch panel 3 when the water droplets WR are detected by the water droplet detection unit 60.

Accordingly, the electronic apparatus 100 can compensate for a decrease in detection sensitivity in the outer circumference portion 3b of the touch panel 3 by providing the water droplet detection unit 60 including dedicated sensors that detect the water droplets WR around the touch panel 3 separately from sensors of the touch panel 3. Therefore, even when the number of electrodes that detect an input to the touch panel 3 is small in the outer circumference portion 3b of the touch panel, the accuracy of distinguishing between an indicator and the water droplets WR are improved. Therefore, the electronic apparatus 100 can prevent a malfunction of the touch panel 3 even when the water droplets WR adhere to the outer circumference portion 3b of the touch panel 3.

When no water droplets WR are detected by the water droplet detection unit 60 any more, the control unit 11 may restore the detection sensitivity of the touch panel 3 to detection sensitivity before the lowering.

Accordingly, the electronic apparatus 100 can easily shorten a period in which the detection sensitivity of the touch panel 3 is low as much as possible by automatically restoring the detection sensitivity as soon as the water droplets WR disappears.

The water droplet detection unit 60 may include a plurality of water droplet detection sensors 6 in a vicinity of respective end sides of the touch panel 3. When at least one of the plurality of water droplet detection sensors 6 detected the water droplets WR, the control unit 11 may lower the detection sensitivity of the touch panel 3.

Accordingly, when it is detected that the water droplets WR are present on any position of the outer circumference portion 3b around the touch panel 3, the electronic apparatus 100 can lower the detection sensitivity of the touch panel 3 and prevent a malfunction of the touch panel.

The water droplet detection unit 60 may include a plurality of water droplet detection sensors 6 arranged in series along one end side of the touch panel 3. When at least one of the plurality of water droplet detection sensors 6 detected the water droplets WR, the control unit 11 may lower the detection sensitivity of the touch panel 3.

Accordingly, in the electronic apparatus 100A, one water droplet detection sensor 6 may be covered by a finger or the like of the user when the user grips the electronic apparatus 100A by one end side of the electronic apparatus 100A. Even in this case, the electronic apparatus 100A can detect the presence or absence of the water droplets WR and accurately set the detection accuracy of the touch panel 3 by, for example, detecting and distinguishing a water signal from a signal of an indicator by any of the water droplet detection sensors 6 arranged along an end portion on the side gripped by the user.

When at least two of the plurality of water droplet detection sensors 6 detected the water droplets WR, the control unit 11 may lower the detection sensitivity of the touch panel 3.

When one water droplet detection sensor 6 disposed in the electronic apparatus 100A is covered by a finger or the like of the user, sweat droplets of the user may be erroneously detected as the water droplets WR. It is assumed that a range gripped by a finger of the user usually falls within a range detectable by one water droplet detection sensor 6. Even in this case, the electronic apparatus 100A can trigger detection of the water droplets WR different from the sweat droplets of the user and prevent a malfunction of the touch panel 3 by lowering the detection sensitivity of the touch panel 3 when at least two water droplet detection sensors 6 detected the water droplets WR.

When the water droplets WR are detected by the water droplet detection unit 60, the control unit 11 may lower detection sensitivity of the outer circumference portion 3b of the touch panel 3 without changing detection sensitivity of the central portion 3a of the touch panel 3.

Accordingly, in the central portion 3a of the touch panel 3, the electronic apparatus 100 can detect an input to the touch panel 3 with the same detection sensitivity as that in normal time even when water droplets are detected. Even in this case, the input detection accuracy is less likely to lower since the water signal and the indicator signal can be distinguished with high accuracy in the central portion 3a of the touch panel 3. Further, the electronic apparatus 100 can prevent a malfunction due to erroneous input detection by lowering the detection sensitivity of the outer circumference portion 3b of the touch panel 3.

Although various embodiments are described above with reference to the drawings, it is needless to say that the present disclosure is not limited to such examples. It will be apparent that those skilled in the art can conceive of various modifications and alterations within the scope described in the claims, and it is understood that such modifications and alterations naturally belong to the technical scope of the present disclosure. Further, elements in the above-described embodiments may be freely combined without departing from the gist of the present disclosure.

### INDUSTRIAL APPLICABILITY

The present disclosure is useful for an electronic apparatus, a method for controlling an electronic apparatus, and the like that can prevent a malfunction of a touch panel even when water droplets adhere to an outer circumference portion of the touch panel.

What is claimed is:

1. An electronic apparatus comprising:
a touch panel;
sensors for detecting water droplets; and
a processor for reducing a detection sensitivity of the touch panel in a case that the sensors detect water droplets, wherein
the sensors are arranged along at least part of an outer circumference of the touch panel and in series along one edge of the touch panel on a side gripped by a user.

2. The electronic apparatus according to claim 1, wherein:
the processor determines a type of water droplets detected by the sensors, and
the processor reduces a detection sensitivity of the touch panel in a case that the processor determines the water droplets are not sweat droplets.

3. The electronic apparatus according to claim 2, wherein:
the processor determines that the detected water droplets are not sweat droplets in a case that at least two of the sensors detect the water droplets.

4. A method of controlling an electronic apparatus including a touch panel, and sensors for detecting water droplets and arranged in series along one edge of the touch panel on a side gripped by a user, the method comprising:
determining a type of water droplets detected by the sensors; and
determining that the detected water droplets are not sweat droplets in a case that at least two of the sensors detect the water droplets.

5. The method of controlling an electronic apparatus according to claim 4, wherein:
reducing a detection sensitivity of the touch panel in a case that determining the detected water droplets are not sweat droplets.
